(19) United States
(12) Patent Application Publication
(10) Pub. No.: US 2005/0287951 A1
(43) Pub. Date: Dec. 29, 2005

(54) Method and apparatus for standard 802.11x network connectivity monitor

(76) Inventor: Mark Poletti, Louisville, CO (US)

Correspondence Address: Mark Poletti, 913 W. Alder St, Louisville, CO, 80027, US

(21) Appl. No.: 10/877,196

(22) Filed: Jun. 28, 2004

(51) Int. Cl. H04B 7/00

(52) U.S. Cl. 455/41.2

(57) ABSTRACT

The purpose of this invention is to provide a wireless 802.11x local area network provider the ability to monitor network connectivity. This invention uses remote units placed at each network access point location and allows for automated sessions to be customized to monitor connectivity. It allows for full-duplex connectivity measurements. It provides the network operator with a method for a remote server to interact with the delivery of measurement data which is used to monitor network connectivity. It also provides the network operator with a method to poll multiple remote units per remote server.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to the wireless local area network wireless service industry using the 802.11x standard.

### BACKGROUND OF THE INVENTION

The Institute of Electrical and Electronic Engineer (IEEE) 802.11x is a set of wireless local area network standards that uses the unlicensed Industrial, Scientific, and Medical (ISM) and Unlicensed National Information Infrastructure (UNII) bands which reside in the following frequency bands: 900 MHz, 2400 MHz, 5100 MHz, 5300 MHz, 5800 MHz.

The invention is applicable to the operators or providers of wireless data service using the 802.11x standard.

Such wireless service provides full-duplex data communication to an Internet Service Provider (ISP) and the internet using a network interface card (NIC), Personal Computer Memory Card International Association (PCMCIA) card, or equivalent connected to a computer.

Currently, wireless service providers providing 802.11x service have limited methods to monitor connectivity of the RF and network link of each serving Access Point. This results in customers not being able to gain access or having degraded throughputs to their network, ultimately causing a loss in revenue.

Current commercially available engineering design and measurement tools utilize multiple apparatus and various interfaces to measure wireless connectivity requiring unique skills, experience, and training. Engineering teams within service operator organizations require individual engineers to physically visit each site and conduct a data call to measure network connectivity. This is a man-power and time intensive task. These measurements are limited in time and scope, for example: once per quarter with one pass at each site location.

Service Operators use customer complaints of service performance which are then translated into network operation trouble tickets. This results in a field engineer to visit the site location and fix the network connectivity problem. This is a reactionary solution and incurs down-time in service before the service is corrected.

2. Advantages

This invention has the following advantages:
(a) Provides the network operator with a remote unit that monitors network connectivity.
(b) Provides the network operator with an automated method to monitor network connectivity.
(c) Provides the network operator with a method to monitor full-duplex network connectivity
(d) Provides the network operator with a method to measure data transfer rate (data rate and throughput) in bi-directions.
(e) Provides the network operator with a method for a remote server to interact with the delivery of measurement data which is used to monitor network connectivity.
(f) Provides the network operator with a method to poll multiple remote units per remote server.
(g) Provides the network operator with a method to remotely test authentication and authorization of various home user and roaming user profiles.
(h) Provides the network operator with an apparatus that is small, low-power, and compact.
(i) Provides a non-service impacting method to monitor network connectivity.
(j) Invention will work in any site location that uses a standard 802.11x access point.

### SUMMARY OF INVENTION

An apparatus is placed within range of an operational 802.11x standard access point and delivers and receives fixed packets (e.g. data files) to monitor network connectivity. This apparatus will interact with a remote server to deliver and receive the fixed packets. Intelligence is built into the remote server that allows for customized time-periods of polling to the remote unit apparatus at one or several access point locations. In addition, the apparatus is configurable to support dynamic user profiles in order for it to test authentication and authorization representative of the service provider's home users as well as roaming users who are customers of other service providers who are roaming partners.

### GENERAL DESCRIPTION OF DRAWINGS

FIG. 1. is a schematic representation of the invention and offers an example design solution of an efficient and cost effective approach for a Standard 802.11x Network Connectivity Monitor.

FIG. 2 is a flow diagram representing a specific operation of the method and system of the invention.

### DETAILED DESCRIPTION OF DRAWINGS

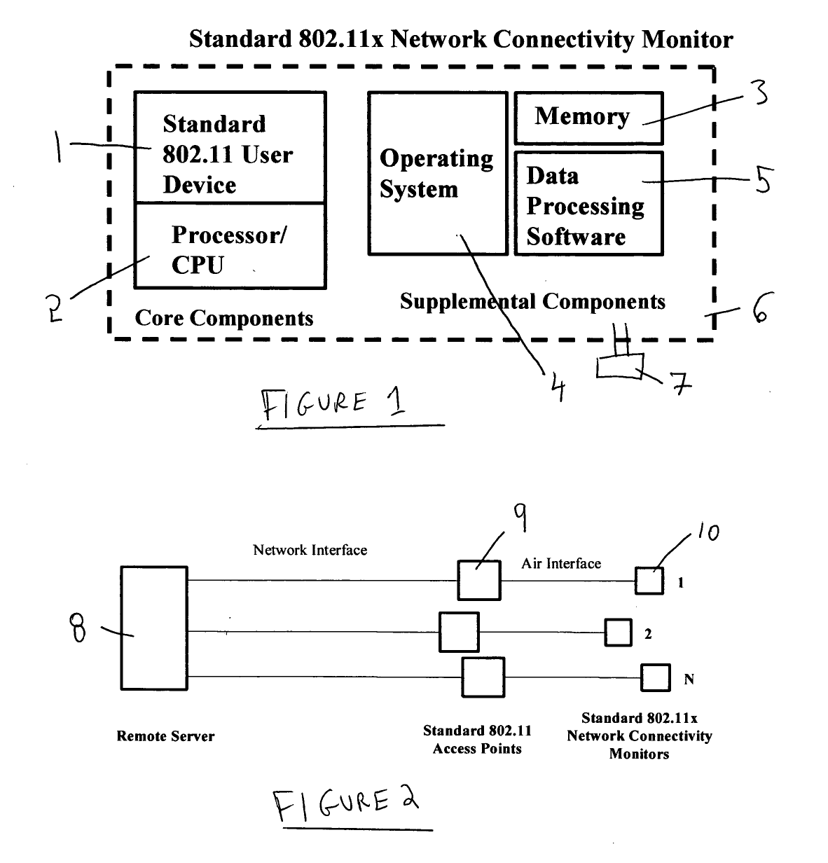

The essential elements of the invention are shown in FIG. 1 which consists of a Standard 802.11x User Device 1 and allows for the establishment, measurement, and verification of network connectivity.

A Processor, such as a Central Processing Unit (CPU), 2 is the main engine of the apparatus. The processor is responsible for controlling the 802.11x user device, the functionality contained in Layer 1, Layer 2 and Layer 3 802.11x data messaging, as well as processing data collection.

Memory 3, (such as removable solid state), is required to store collected data from the measurement device as well as network identification information.

The Operating System 4 manages complete operation of the device.

The Data Processing Method 5, such as those embodied in software or firmware, will reside on the processor and will perform memory management and the delivery/receipt of fixed packets as well as other similar functional processing.

The entire apparatus will be in a compact enclosure 6 and will be provided to the user in the form of a single unit.

The apparatus will have multiple power options 7 such as battery, a/c power, d/c power.

FIG. 2 shows an example of the operation of the apparatus. A Remote Server 8 can deliver and receive to/from multiple standard 802.11x access points 9 and multiple apparatuses or Standard 802.11x Network Connectivity Monitors 10.

1. The method of operation of this apparatus is automated and requires little or no interaction with the user.

2. This apparatus monitors full-duplex network connectivity.

3. This apparatus allows for customizable time periods (of network monitoring) at the remote server.

4. This apparatus allows for customizable user profiles for testing authentication and authorization.

5. This apparatus is less costly due to the simplistic design that eliminates the need for a standard 802.11x user card and a fully-loaded personal computer to measure network connectivity.

6. The method of operation of this apparatus is simple. It requires no training, no special skills, no experience in the wireless industry, and no knowledge of proprietary information.

7. The apparatus is in the form of a single, compact unit.
